(19) United States
(12) Patent Application Publication
(10) Pub. No.: US 2006/0058446 A1
(43) Pub. Date: Mar. 16, 2006

(54) Rheology control for adhesives based on formaldehyde resins

(76) Inventors: John S. Manka, Chagrin Falls, OH (US); Todd K. Yonker, Chagrin Falls, OH (US); John S. Perz, Mentor, OH (US)

Correspondence Address: Teresan W Gilbert;Lubrizol Corporation, Patent Administrator-Mail Drop 022B, 29400 Lakeland Blvd, Wickliffe, OH, 44092-2298, US

(21) Appl. No.: 10/518,875

(22) PCT Filed: Jul. 2, 2003
(86) PCT No.: PCT/US03/20755

§ 371 Date: Aug. 5, 2005

Related U.S. Application Data
(60) Provisional application No. 60/394,051, filed on Jul. 3, 2002.

(51) Int. Cl. C09B 67/00

(52) U.S. Cl. 524/502

(57) ABSTRACT

Water soluble polymers are incorporated into cellulose adhesives comprising phenol formaldehyde and related formaldehyde resins to impart more resistance to sagging and to increase the open time of the adhesive. A preferred use of the modified adhesive is as an adhesive for assembling engineered wood products such as strand board, particle board, medium density fiberboard, plywood and engineered products such as I-beams. The water soluble polymers achieve the objectives of increased sag resistance and more open time by increasing the viscosity of the adhesive and slowing the loss of water to the cellulose products and the air during use of the adhesive.

### FIELD OF INVENTION

Water soluble polymers are added to adhesive binder resins used to bond cellulosic composites such as oriented strand board, particle board, medium density fiberboard, plywood and other engineered wood products. They improve the resin rheology by reducing run off and sag of the adhesive resin along with increasing the “open time” (time during which adhesive joints are optimally made) of the resin by increasing water retention time. Often these waterborne binder resins are phenol-formaldehyde resins, modified phenol-formaldehyde resins, urea formaldehyde resins, or melamine formaldehyde resins.

### BACKGROUND OF THE INVENTION

Resin bound cellulosic composites such as oriented strand board, particle board, chip board, and plywood are commonly used construction materials and are well known to the art. Resin binders for engineered composites are also well known and include phenol-formaldehyde resins, isocyanate resins, melamine formaldehyde resins, urea formaldehyde resins, and blends containing reactants from one or more of the above reactive resins. The particular resin depends upon the particular manufacturing process used to form the composite, the desired viscosity of the binder, the reaction conditions under which the resin binder is to cure, and the amount of moisture that may be in the cellulosic material used.

Resin bound cellulosic materials are often further processed, cut and glued on assembly lines using water based resins systems such as phenol formaldehyde, urea formaldehyde and melamine formaldehyde adhesives. These are often applied as beads of adhesive to one cellulosic part and then a second cellulosic part is brought into contact with the adhesive material and a bond is formed. While these adhesives work very well there are sometimes problems with rheology control in that the adhesive sags from or soaks into the original application area, especially if the adhesive is applied to the side or bottom of a cellulosic part. Another problem that occurs from time to time is that the adhesive “open time” is exceeded during a manufacturing step due to line stoppages and either the adhesive and cellulosic part require reprocessing or are scrapped due to the adhesive becoming too dry, hard, and viscous to form a good adhesive bond.

### SUMMARY OF INVENTION

Water based resins selected from the class including phenol formaldehyde, urea formaldehyde, melamine formaldehyde, blends thereof and related water dilutable resins are modified with water soluble polymers to increase the sag resistance and increase the “open time” of the resin. The water soluble polymers have an attraction for water that exceeds that of the resins so the water soluble polymers slow down the transfer of water from the formulated adhesive to the surrounding air and the cellulosic substrates being adhered. This slow down of water loss functions to increase the “open time” when the adhesive is fluid enough to form an effective adhesive bond between two substrates. Another benefit of the water soluble polymers is their ability to form a gel like structure under low shear. Under high shear this gel structure breaks down to yield a lower viscosity that facilitates wetting of the substrates. Wetting of the substrates makes for more contact area and a better adhesive bond Under low shear this gel structure thickens the adhesive such that the adhesive is subject to less sagging when applied to the sides or bottom of a substrate. Excessive soaking of the substrate is also reduced. A preferred water soluble polymer is a polymer containing at least 5 weight percent repeating units derived from 2-acrylamido-2-methylpropane sulfonic acid or its metal or ammonium salt.

### DETAILED DESCRIPTION OF THE INVENTION

The resins of the adhesive are described as phenol formaldehyde, urea formaldehyde, melamine formaldehyde, blends thereof, and related resins. This term is meant to encompass the commercially available resins from formaldehyde and phenol or the various amines with formaldehyde. These are well known to the art and need little further description. While they can be manufactured with little water compatibility, most forms of these resins tend to have good water solubility until they achieve fairly high molecular weight or significant amounts of crosslinking. They will be described herein as water compatible meaning that they can be diluted with water and have an attraction for water until they are crosslinked or reach higher molecular weights. The resins will be characterized as the base components and many of the additives will be based on being a percent based on the weight of the resins. The weight of the resins will be absent any water used to manufacture, dilute, or carry the resins.

The water soluble polymers useful as additives for rheology control (sag resistance) and increased open time will be polymers other than the described resins which have an attraction for water such that they dissolve in water or swell in water to 100 percent beyond their original weight. These polymers may be linear or branched but will generally not be highly crosslinked. They can be used above 0.1 weight percent in the resins of the adhesive, more desirably from about 0.1 to about 20 weight percent, more desirably still from about 0.1 to about 10 weight percent and preferably from about 0.25 to about 5 weight percent.

A preferred water soluble polymer is a polymer that includes at least 5 weight percent repeating units derived from free radically polymerizing a 2-acrylamido-2-methylpropane sulfonic acid or its metal salt, said salt having cations selected from the group consisting of alkali metal cations, alkaline earth cations, cations of the following transition metals: Sc, Ti, V, Cr, Mn, Fe, Co, Ni, Cu, Zn or ammonium cations of the following formula: R₁R₂R₃R₄N⁺, wherein R₁, R₂, R₃ and R₄ are independently hydrogen or hydrocarbyl groups. A preferred salt is sodium. This monomer is available from the Lubrizol Corporation under the trademark AMPS monomer. Polymer will be used to include copolymers including two or more monomer types. Desirably the amount of repeating units derived from AMPS monomer will be from about 10 to about 100 weight percent, more desirably from about 15 to 70 weight percent of the water soluble polymer. The use of AMPS monomers in polymers is well known to the patent art. U.S. Pat. Nos. 4,555,558; 5,128,046; and 5,215,668 along with a multitude of other patents teach copolymerizing AMPS monomers with other monomers to form partially or completely water soluble polymers. Desirably the water soluble polymer is a high molecular weight polymer such that the number average molecular weight is above 100,000 and more desirably about 250,000 or 500,000.

A surfactant gel can be used in the adhesive resin in addition to or in lieu of the water soluble polymer. The surfactant gel forms a slightly different type of gel with slightly different anti-sag properties and slightly different effect on the “open time” of the adhesive. The surfactant gel is formed from a combination of a cationic and an anionic surfactant. Both types of surfactants are well known to the art. Lists of anionic and cationic surfactants suitable to make gels are given in McCutcheon's Emulsifiers & Detergents, North American Edition 1993, ISBN 0-944254-22-5, published by McCutcheon Division of Manufacturing Confectioner Co., in Glen Rock N.J. An example of a cationic surfactant is cocamide betaine. An example of an anionic surfactant is sodium lauryl sulfate. To achieve the gel both the cationic and the anionic surfactant must be present. However the cationic and anionic surfactant need not come in contact until the final adhesive is formed. Thus the surfactants can be separately added to a portion or a component of the adhesive and then the surfactants will be combined together in the final adhesive. Desirably the amount of cationic surfactant is from about 0.1 to about 10 weight percent, more desirably from about 0.25 to about 1 or 2 weight percent based on the weight of the resin. Desirably the amount of anionic surfactant is from about 0.1 to about 10 weight percent and more desirably from about 0.25 to about 1 or 2 weight percent based on the weight of the resin.

The formation of the adhesive follows steps well known to the art of manufacturing resin based adhesives for wood products. The various components are metered out, added together and mixed to form a homogenous mixture. Fillers, fiber, colorants, formaldehyde scavengers, etc. can be added. Any desired catalysts can be added to the initial mix or metered in to the components closer to the time that the adhesive is dispensed for use. Heat may be added to facilitate the mixing or cause individual components to react.

As used herein, the term “hydrocarbyl”, “hydrocarbyl substituent” or “hydrocarbyl group” is used in its ordinary sense, which is well known to those skilled in the art. Specifically, it refers to a group having a carbon atom directly attached to the remainder of the molecule and having predominantly hydrocarbon character. Examples of hydrocarbyl groups include:
(1) hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule;
(2) substituted hydrocarbon substituents, that is, substituents containing non-hydrocarbon groups which, in the context of this invention, do not alter the predominantly hydrocarbon substituent [e.g., halo—especially chloro and fluoro), hydroxy, alkoxy, mercapto, alkylmercapto, nitro, nitroso, and sulfoxy];
(3) hetero substituents, that is, substituents which, while having a predominantly hydrocarbon character, in the context of this invention, contain other than carbon in a ring or chain otherwise composed of carbon atoms. Heteroatoms include sulfur, oxygen, nitrogen, and encompass substituents as pyridyl, furyl, thienyl and imidazolyl. In general, no more than two, preferably no more than one, non-hydrocarbon substituent will be present for every ten carbon atoms in the hydrocarbyl group; typically, there will be no non-hydrocarbon substituents in the hydrocarbyl group.

The term “hydrocarbyl” is also intended to include hydrocarbylene, that is, groups having bonds to non-hydrocarbon functionality at two places, i.e., two open valences.

No attempt will be made in this application to fully define all of the reaction conditions used to prepare phenol formaldehyde, melamine formaldehyde, and urea formaldehyde resins. Phenol formaldehyde resins are described in basic polymer textbooks such as Principles of Polymerization, 2nd edition by George Odian, published in 1981 by John Wiley & Sons Inc. as a Wiley-Interscience publication. Pages 128-133 of Odian's book give general teachings on catalyzed phenol formaldehyde reaction products. Pages 133-135 give general teachings on amino-plastics, which include urea formaldehyde and melamine formaldehyde. Pages 139-140 gives general teachings on phenol formaldehyde reaction products called structopendant phenol-formaldehyde prepolymers or nonovolacs. Sometimes phenol formaldehyde resins are called resol prepolymers or resoles. Another name for a group of phenol formaldehyde resins is resorcinol resins. Phenol formaldehyde and amino (e.g. urea formaldehyde and melamine formaldehyde) resins are also described in Textbook of Polymer Science, 3rd edition, by Fred W. Billmeyer, Jr. and published by John Wiley & Sons as a Wiley-Interscience publication on pages 436-442. The relevant sections of both books are hereby incorporated by reference.

A preferred use of the adhesive resin modified with the water soluble polymer and/or surfactant gel is in various wood composites and engineered wood products. Essential components of engineered wood products assembled using the modified binder resins are cellulosic substrates e.g. lumber or a material with a large amount of cellulosic material, e.g. wood in some form, and a smaller amount, effective to bind the cellulosic material into an adherent mass of a resin binder, such as phenol-formaldehyde. The use of these modified resin adhesives is common in furniture, pallets, floors, building sheathing applications, etc.

Desirably the cellulosic material is some form of wood such as wood veneers, wood chips, wood particles, and wood fibers (also known as ligno cellulosics). These materials along with a resin binder are used to form a variety of structural materials such as plywood, chipboard, wafer board, particle board, medium density fiberboard, oriented strand board (OSB), laminated veneer lumber (LVL) other wood composite boards, etc that are used in construction and various other applications. Important criteria for these materials include modulus (rigidity); resistance to cracking, resistance to edge swell, moisture, water, and change in properties on aging; and compatibility and effective interaction with other construction materials such as nails, screws, adhesives etc. Desirably these products have at least 80 weight percent of cellulosic materials (ligno cellulosics) therein (such as a natural wood product) and at least 1 or 2 weight percent of a synthetic resin binder, and up to 18 or 19 weight percent of other materials such as waxes, fillers, waterproofing agents, resin hardeners or catalysts, co-adhesives, such as Polyacrylates, colorants, etc. More desirably these products have at least 90 weight percent cellulosic materials, about 1 or 2 to about 10 weight percent of a resin binder, and up to 8 or 9 weight percent of the other additives. Preferably these products have at least 95 weight percent of cellulosic materials, about 1 or 2 to about 5 weight percent of a resin binder, and up to 3 or 4 weight percent of said other additives.

The engineered wood products can be a variety of man made composites that compete against structural lumber. Resin binders hold cellulosic materials (fibers and their natural resin binders) together to make larger structural wood products. These include oriented strand board (OSB) which appears as chips of wood having at least one dimension greater than 1 cm held together with a commercial binder. Another product is particle board, which is similar to OSB but using smaller fiber lengths and the particle board typically has lesser strength. Medium density fiberboard is a denser version of particle board designed to have more strength. Plywood is a composite of wood veneers and wood chips or particles laminated together with a resin binder. Plywood often has a particular soft or hardwood veneer on at least one side that can be stained or otherwise finished to provide an attractive exposed surface. All of the above wood products can be used in applications where strength and stiffness are required such as roofs, floors, walls, etc. This may be called sheathing or underlayment in these applications. They may be made fire retardant or moisture resistant for these applications.

The engineered wood product may also be a laminate of smaller wood pieces assembled together with a resin binder to make a larger piece of wood or a structurally superior (engineered) wood shape. A common name for wood products made by lamination of multiple wood pieces is laminated veneer lumber (LVL). A common designed or engineered shape is a wood I-beam or joist prepared from OSB and LVL. These typically comprise two long (e.g. rectangular in cross-section) LVLs held together with an intervening web of thinner OSB. These types of engineered shapes take advantage of the lower volume and weight of the web and the high compressive and tensile strength of the LVL.

Wood composites such as oriented strand board, particle board, and plywood are assembled with a variety of techniques. The resin binders may be added as powders, liquids, binders in water, or binders in other solvents. The wood composites may be pre-shaped by laying out desired volumes or weights of materials in specific order and then compression and shaping. The manufacturing processes can be batch, continuous or variations thereof. They can be wet or dry processes. The processes may use other binders such as urea formaldehyde, melamine formaldehyde, epoxy systems, or urethane systems. If the resin binder is to be crosslinked, that can be achieved with heat, catalysts, and various radiations such as R.F. or microwaves. Formaldehyde scavengers may be added to the composites to minimize the release of free formaldehyde during manufacture or use. The resin binders (adhesive) may be applied by spray, curtain coater, roll spreader, foam application equipment or simpler mixing techniques.

### EXAMPLES

A commercial adhesive phenol formaldehyde resin was obtained. It was treated with a water soluble polymer including 68 mole percent of repeating units from sodium 2-acrylamido-2-methylpropane sulfonate and 32 mole percent repeating units from t-butyl acrylamide. The water soluble polymer was pre-diluted with a specified amount of water to facilitate incorporation. Samples of the resin were treated with from about 1 to about 10 weight percent of the water soluble polymer (based on neat weight of the polymer). A control was run with a nearly identical amount of water as used in the examples being added to the control. The amount of sag of a bead of resin was determined. Even as little as 1 weight percent of water soluble polymer produced a measurable decrease in the amount of sag of the resin. Similarly an increase in the “open time” of the adhesive resin was observed.

While the invention has been explained in relation to its preferred embodiments, it is to be understood that various modifications thereof will become apparent to those skilled in the art upon reading the disclosure. Therefore, it is to be understood that the invention disclosed herein is intended to cover such modifications as fall within the scope of the appended claims.

What is claimed is:

1. An adhesive comprising; a resin selected from the group of phenol formaldehyde, urea formaldehyde, melamine formaldehyde or a blend thereof including from about 0.1 to about 20 weight percent, based on the resin weight, of a water soluble polymer.

2. An adhesive according to claim 1, wherein said water soluble polymer includes at least 5 weight percent of repeating units from free radically polymerizing 2-acrylamido-2-methylpropane sulfonic acid or its salt, said salt having a cation selected from the group consisting of alkali metal cations; alkaline earth cations; cations of the following transition metals: Sc, Ti, V, Cr, Mn, Fe, Co, Ni, Cu, or Zn; or ammonium cations of the following formula: R₁R₂R₃R₄N⁺, wherein R₁, R₂, R₃ and R₄ are independently hydrogen or hydrocarbyl groups.

3. An adhesive according to claim 1, wherein said water soluble polymer includes at least 5 weight percent of repeating units from free radically polymerizing 2-acrylamido-2-methylpropane sulfonic acid or its sodium or ammonium salt, wherein R₁, R₂, R₃ and R₄ are hydrogen.

4. An adhesive according to claim 2, wherein said water soluble polymer includes from about 10 to about 80 weight percent of repeating units from free radically polymerizing sodium-2-acrylamido-2methylpropane sulfonate.

5. An adhesive according to claim 1, wherein said resin is sufficiently compatible with water such that water can be used as a solvent to dilute its viscosity.

6. An adhesive according to claim 1, used to adhere one or more cellulose based materials to another cellulose based material.

7. An adhesive according to claim 6, wherein at least one of said cellulose based materials comprises a cellulose based material including wood chips, wood flour, ground wood, or wood fibers.

8. An adhesive according to claim 1, wherein said water soluble polymer increases the sag resistance of a one-eighth inch diameter bead of said adhesive by at least 10 percent over the normal working time of the adhesive.

9. An adhesive according to claim 1, wherein said water soluble polymer increases the open time (time during which effective bonds between two substrates are easily made) of the adhesive by at least 10 percent over the normal working time of the adhesive.

10. An adhesive according to claim 1, wherein said water soluble polymer decreases the evaporation rate of water from a one-eighth inch diameter bead of said adhesive during the first 4 minutes after formation into a bead by at least 20 percent.

11. An adhesive according to claim 1, wherein said water soluble polymer decreases the rate of water absorption into the wood substrate from a one-eighth inch diameter bead of said adhesive during the first 4 minutes after formation into a bead by at least 20 percent.

12. An adhesive according to claim 1, further including at least 0.1 weight percent of a cationic surfactant and at least 0.1 weight percent of an anionic surfactant.

13. An adhesive according to claim 7, wherein said cellulose based material comprised of at least 90 weight percent of ligno cellulosic material.

14. An adhesive according to claim 13, wherein said ligno cellulosic material is formed into a particle board, chipboard, oriented strand board, medium density fiberboard, plywood, or paneling.
